(19) United States
(12) Patent Application Publication
(10) Pub. No.: US 2024/0176894 A1
(43) Pub. Date: May 30, 2024

(54) A CRITICAL INFRASTRUCTURE SIMULATION AND EMULATION SYSTEM AND METHOD

(71) Applicant: THE ISRAEL ELECTRIC CORPORATION LTD., Haifa (IL)

(72) Inventors: Leonid LEV, Haifa (IL); Lev GURVICH, Haifa (IL); Motti COHEN, Haifa (IL); Sergey MAZO, Haifa (IL)

(21) Appl. No.: 18/551,600

(22) PCT Filed: Feb. 17, 2022
(86) PCT No.: PCT/IL2022/050188

§ 371 Date: Sep. 21, 2023

(30) Foreign Application Priority Data
Mar. 24, 2021 (IL) 281754

(51) Int. Cl. G06F 21/57; G06F 21/55; G06F 30/20

(52) U.S. Cl. CPC G06F 21/577; G06F 21/554; G06F 30/20; G06F 2221/034

(57) ABSTRACT

A simulation and emulation system for critical infrastructure comprising one or more components, the system comprising at least one processing circuitry configured to: obtain a model including: a plurality of Dynamic Digital Emulation Models (DDEMs), and one or more operational procedures configured to cause reconfiguration of one or more of the DDEMs upon events taking place; execute one or more scenarios comprised of a sequence of one or more actions on the model, at least one of the actions causes triggering at least one of the events, thereby causing changes to one or more of parameters of one or more first DDEMs of the DDEMs, the changes triggers execution of one or more operational procedures, thereby causing reconfiguration of one or more second DDEMs of the DDEMs; analyze the model to identify implications of the scenarios execution; and perform one or more actions based on results of the analysis.

### TECHNICAL FIELD

The invention relates to a critical infrastructure simulation and emulation system and method.

### BACKGROUND

Current cyber-attack simulation tools can assist with understanding organization's cyber vulnerabilities by pitting an emulation of its cyber defenses against simulated real-life attack scenarios. While the detection, coordination and response capabilities of critical infrastructure systems to cyber-attacks ultimately determine the economic and societal impact of infrastructure disruptions, current cyber-attack emulation and simulation solutions support for Operational Technology (OT) systems are insufficient. In particular, solutions that are based on OT Systems inter-dependent emulation models that can be reconfigured in real-time or near real-time upon operational procedures being executed—are non-existent. The lacking of such tool results in an inability to reliably plan systems, safely changing existing systems, purchasing decisions, integration planning, etc.

In order to address not only the Information Technology (IT) aspect of the organization but also its OT cyber sturdiness and more, there is a need in the art for a new critical infrastructure simulation and emulation system and method.

### GENERAL DESCRIPTION

In accordance with a first aspect of the presently disclosed subject matter, there is provided a simulation and emulation system for critical infrastructure, the critical infrastructure comprising one or more components, the system comprising at least one processing circuitry configured to: obtain a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place; execute one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models; analyze the model to identify implications of the execution of the scenarios; and perform one or more actions based on results of the analysis other than the first dynamic digital emulation models.

In some cases, the model is an electrical grid simulation model and wherein the reconfiguration of one or more second dynamic digital emulation models of the dynamic digital emulation models causes a connection of at least one of the second dynamic digital emulation models to the electrical grid simulation model or a disconnection of at least one of the second dynamic digital emulation models from the electrical grid simulation model;

In some cases, at least one of the dynamic digital emulation models emulates at least one Operational Technology (OT) component.

In some cases, the simulation and emulation system further comprises one or more virtual digital models, wherein each virtual digital model represents at least one of the components of the critical infrastructure.

In some cases, the virtual digital models are Information Technology (IT) models.

In some cases, the model is configured to connect to one or more physical components of the critical infrastructure.

In some cases, at least one of the scenarios simulating real-world scenarios is a simulation of a cyber-attack.

In some cases, the simulation of the cyber-attack is based on a MITRE ATT&CK® ICS framework or on MITRE ATT&CK® framework.

In some cases, the one or more actions are one or more of: alerting a user, suggesting one or more remediation actions, providing information of one or more identified vulnerabilities, providing information of successful cyber-attacks performed on the model, providing information of a risk level of each of one or more of the components, providing information of known adversaries.

In some cases, the remediation actions include one or more of: introduction of one or more missing SIEM rules, reconfiguration of one or more of the components of the critical infrastructure, changing a topology of the critical infrastructure, adding components to the critical infrastructure or suggesting to modify one or more parameters of the critical infrastructure.

In some cases, the processing circuitry is further configured to perform the remediation actions on the model and validate that the remediation actions solve at least one negative implication of the implications of the execution of the scenarios.

In some cases, at least one of the scenarios is a simulation of an ongoing cyber-attack occurring on the critical infrastructure.

In accordance with a second aspect of the presently disclosed subject matter, there is provided a simulation and emulation method for critical infrastructure, the critical infrastructure comprising one or more components, the method comprising: obtaining a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place; executing one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models, other than the first dynamic digital emulation models; analyzing the model to identify implications of the execution of the scenarios; and performing one or more actions based on results of the analysis.

In some cases, the model is an electrical grid simulation model and wherein the reconfiguration of one or more second dynamic digital emulation models of the dynamic digital emulation models causes a connection of at least one of the second dynamic digital emulation models to the electrical grid simulation model or a disconnection of at least one of the second dynamic digital emulation models from the electrical grid simulation model; In some cases, at least one of the dynamic digital emulation models emulates at least one Operational Technology (OT) component.

In some cases, the method further comprises one or more virtual digital models, wherein each virtual digital model represents at least one of the components of the critical infrastructure.

In some cases, the virtual digital models are Information Technology (IT) models.

In some cases, the model is configured to connect to one or more physical components of the critical infrastructure.

In some cases, at least one of the scenarios simulating real-world scenarios is a simulation of a cyber-attack.

In some cases, the simulation of the cyber-attack is based on a MITRE ATT&CK® ICS framework or on MITRE ATT&CK® framework.

In some cases, the one or more actions are one or more of: alerting a user, suggesting one or more remediation actions, providing information of one or more identified vulnerabilities, providing information of successful cyber-attacks performed on the model, providing information of a risk level of each of one or more of the components, providing information of known adversaries.

In some cases, the remediation actions include one or more of: introduction of one or more missing SIEM rules, reconfiguration of one or more of the components of the critical infrastructure, changing a topology of the critical infrastructure, adding components to the critical infrastructure or suggesting to modify one or more parameters of the critical infrastructure.

In some cases, the method further comprises performing the remediation actions on the model and validating that the remediation actions solve at least one negative implication of the implications of the execution of the scenarios.

In some cases, at least one of the scenarios is a simulation of an ongoing cyber-attack occurring on the critical infrastructure.

In accordance with a third aspect of the presently disclosed subject matter, there is provided a non-transitory computer readable storage medium having computer readable program code embodied therewith, the computer readable program code, executable by at least one processor to perform a simulation and emulation method for critical infrastructure, the critical infrastructure comprising one or more components, the method comprising: obtaining a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place; executing one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models, other than the first dynamic digital emulation models; analyzing the model to identify implications of the execution of the scenarios; and performing one or more actions based on results of the analysis.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of a critical infrastructure environment that can be simulated and emulated by a critical infrastructure simulation and emulation system in accordance with the presently disclosed subject matter;

FIG. 2 is a block diagram schematically illustrating one example of critical infrastructure simulation and emulation system, in accordance with the presently disclosed subject matter;

FIG. 3 is a flowchart illustrating one example of a sequence of operations carried out for simulating and emulating critical infrastructure, in accordance with the presently disclosed subject matter: and

FIG. 4 is a flowchart illustrating one example of a sequence of operations carried out for performing and validating remediation actions on the simulation and emulation critical infrastructure, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “executing”, “analyzing”, “performing”, “alerting”, “suggesting”, “providing”, “validating”, or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

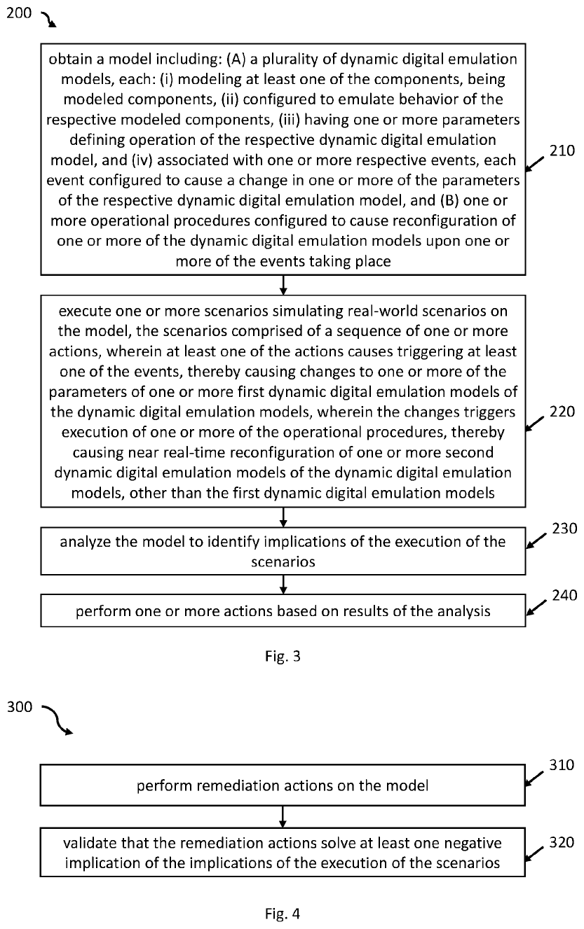

In embodiments of the presently disclosed subject matter, fewer, more and/or different stages than those shown in FIG. 3 or 4 may be executed. In embodiments of the presently disclosed subject matter one or more stages illustrated in FIG. 3 or 4 may be executed in a different order and/or one or more groups of stages may be executed simultaneously. FIG. 2 illustrates a general schematic of the system architecture in accordance with an embodiment of the presently disclosed subject matter. Each module in FIG. 2 can be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

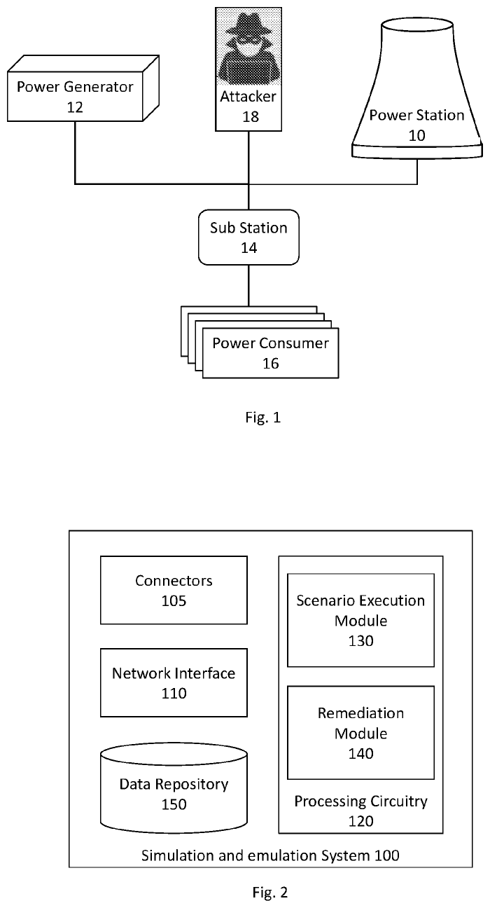

Bearing this in mind, attention is drawn to FIG. 1 is a schematic illustration of a critical infrastructure environment that can be simulated and emulated by a critical infrastructure simulation and emulation system in accordance with the presently disclosed subject matter.

In the schematic illustration, a power station 10 is shown. The power station 10 supplies power to sub-station 14, which can also be powered by a power generator 12, for example when the power station 10 cannot provide power thereto (e.g., when the power station 10 is malfunctioning). The sub-station 14 in turn, supplies power to a plurality of power consumers 16, such as households, office buildings, factories, or any other type of power consumer. It is to be noted that in some cases, the critical infrastructure environment can be much more complicated, and can include a plurality of power stations such as power station 10, each of which can supply power to many sub-stations, other than sub-station 14, and each sub-station can supply power to a plurality of power consumers, other than power consumers 16. Put in other words, the illustrated example is a simplified example that is used in order to simplify the explanation about the presently disclosed subject matter.

The illustration further shows an attacker 18, that can attempt to attack the critical infrastructure, optionally using cyber-attacks. For this purpose, the attacker 18 can somehow gain access to various components of the critical infrastructure (e.g., to a power generator 12, to a sub-station 14, to a power station 10, or to specific parts thereof such as Programmable Logic Controllers (PLCs), Remote Terminal Units (RTUs), sensors, IT systems, security appliances, etc.) and cause damage thereto.

In a specific example, the attacker 18 can gain access to an Rounds Per Minute (RPM) sensor of an engine of the power generator 12, and cause it to constantly show RPM within a normal range, while the attacker 18 can cause the engine to malfunction by exceeding the allowed RPM of the engine. This may lead to destruction of the power generator 12 so that it will not operate when it is required to operate.

Clearly, it is in most cases impossible to test what happens to the live critical infrastructure when changes are made thereto, or when it is under cyber-attack, as it may risk the live critical infrastructure. In the example provided above, it is unlikely that an actual cyber-attack will be made on the actual power generator 12, as it puts the entire critical infrastructure at risk. Thus, it is desirable to have the ability to model the critical infrastructure environment, or parts thereof, in order to investigate how it may be affected by changes and/or by cyber-attacks. As further detailed herein, according to the presently disclosed subject matter, such a model is presented herein.

Turning to FIG. 2, there is shown a block diagram schematically illustrating one example of critical infrastructure simulation and emulation system, in accordance with the presently disclosed subject matter.

In accordance with the presently disclosed subject matter, critical infrastructure simulation and emulation system 100 (also interchangeably referred to herein sd: “system 100”) can comprise a network interface 110 (e.g., a network card, a WiFi client, a LiFi client, 3G/4G client, or any other component), enabling system 100 to communicate over a network with external systems. Additionally, or alternatively, system 100 can comprise one or more connectors 105, enabling system to connect physical components of critical infrastructure (e.g., PLCs, RTUs, sensors, IT systems, security appliances, etc.) thereto. It is to be noted that when reference is made herein to critical infrastructure, it may refer to various industries including energy (electricity, oil and gas, etc.), chemicals, communications, critical manufacturing, financial services, food and agriculture, healthcare and public health, transportation systems, water and wastewater, etc.

System 100 can further comprise, or be otherwise associated with, a data repository 150 (e.g., a database, a storage system, a memory including Read Only Memory—ROM, Random Access Memory—RAM, or any other type of memory, etc.) configured to store data, optionally including, inter alia, one or more dynamic digital emulation models, one or more operational procedures, operational history information, one or more virtual digital models (e.g., virtual IT models), etc. Data repository 150 can be further configured to enable retrieval and/or update and/or deletion of the stored data. It is to be noted that in some cases, data repository 150 can be distributed, while the system 100 has access to the information stored thereon, e.g., via a wired or wireless network to which system 100 is able to connect (utilizing its network interface 110).

System 100 further comprises a processing circuitry 120. Processing circuitry 230 can be one or more processing units (e.g., central processing units), microprocessors, microcontrollers (e.g., microcontroller units (MCUs)) or any other computing devices or modules, including multiple and/or parallel and/or distributed processing units, which are adapted to independently or cooperatively process data for controlling relevant system 100 resources and for enabling operations related to system's 100 resources.

Processing circuitry 120 can comprise a scenario execution module 130, and a remediation module 140. Scenario execution module 130 can be configured to execute one or more scenarios simulating real-world scenarios, as further detailed herein, inter alia with reference to FIG. 2. Remediation module 140 can be configured to perform remediation actions and optionally to validate them, as further detailed herein, inter alia with reference to FIG. 3.

It is to be noted that although reference is made throughout the detailed description to critical infrastructure, the teachings herein can be applied on other types of systems, mutatis mutandis, and it is not limited to critical infrastructure which is used herein as a non-limiting example.

Turning to FIG. 3, there is shown a flowchart illustrating one example of a sequence of operations carried out for simulating and emulating critical infrastructure, in accordance with the presently disclosed subject matter.

In accordance with the presently disclosed subject matter, a simulation and emulation system is provided, that is based on a modeling of inter-dependent dynamic digital emulation models that can be reconfigured in real-time or near real-time (e.g., a few seconds, less than a second, and optionally less than ten milliseconds or even less) upon execution of operational procedures associated therewith.

Accordingly, system 100 can be configured to perform a scenario execution process 200, e.g., using Scenario execution module 130.

For this purpose, system 100 obtains a model including: (A) one, or more (e.g. a plurality of), dynamic digital emulation models, and (B) one or more operational procedures configured to cause reconfiguration of one or more of the dynamic digital emulation models upon one or more events, configured to cause a change in one or more of the parameters of the respective dynamic digital emulation model, taking place (block 210).

Each of the dynamic digital emulation models is: (i) modeling one or more components of critical infrastructure (referred to herein as: “modeled components”), such as controllers, power lines, power circuits, power generation elements (turbines, generators, etc.), pumps, etc., (ii) configured to emulate behavior of the respective modeled components, (iii) having one or more parameters defining operation of the respective dynamic digital emulation model (e.g. controller inputs and outputs, power circuit loads, turbine's Rounds Per Minute (RPM), power line capacity, etc.), and (iv) associated with one or more respective events, each of which being configured to cause a change in one or more of the parameters of the respective dynamic digital emulation model.

The modeled components can be models of physical and/or logical components of the critical infrastructure (e.g., hardware components and/or software components of the critical infrastructure). In some cases, at least one of the dynamic digital emulation models emulates at least one OT component of the critical infrastructure, such as PLC controllers, Supervisory Control And Data Acquisition (SCADA) controllers, valves, machinery, sensors, actuators, lighting fixtures, etc.

In some cases, the model obtained at block 210 further comprises one or more virtual digital models, each of which represents at least one of the components of the critical infrastructure. Such virtual digital models can model IT components of the critical infrastructure, such as, multipurpose computing devices (desktop/laptop computers, servers, smartphones, etc.), firewall hardware and/or software, cyber security software (e.g., antivirus, Security Information and Event Management (SIEM), Endpoint Detection and Response (EDR) software, etc.), or any other IT component that can form part of the critical infrastructure.

In some cases, the model obtained at block 210 can be configured to physically connect (e.g., via connectors 105) to one or more physical components of the critical infrastructure, such as PLC controllers, Supervisory Control And Data Acquisition (SCADA) controllers, valves, machinery, sensors, actuators, lighting fixtures, etc., and to critical infrastructure such as: controllers, power lines, power circuits, power generation elements (turbines, generators, etc.).

System 100 is configured to execute one or more scenarios simulating real-world scenarios on the model (block 220). The scenarios that are executed on the model are comprised of a sequence of one or more actions, at least one of which causes triggering at least one of the events that are configured to cause a change in one or more of the parameters of one or more first dynamic digital emulation models of the dynamic digital emulation models. Triggering of at least one of the events causes changes to one or more of the parameters of one or more of the dynamic digital emulation models, which in turn triggers execution of one or more of the operational procedures (for example, when simulating an electrical grid, when the power consumption exceeds a threshold, an event is triggered to turn on an additional generator, which causes a change in a parameter of a modeled component modeling the generator). The execution of such operational procedures causes real time or at least near real-time (e.g., a few seconds, less than a second, and optionally less than ten milliseconds or even less) reconfiguration of one or more second dynamic digital emulation models of the dynamic digital emulation models that the operational procedures are associated with, other than the first dynamic digital emulation models.

It is to be noted that critical infrastructure that can be modeled in accordance with the teachings herein can be extremely complicated and can include tens, hundreds, or even thousands or more critical infrastructure components, each optionally being modeled by a respective dynamic digital emulation model. Each dynamic digital emulation model (modeling a critical infrastructure component) can affect and/or be affected by other dynamic digital emulation models. Therefore, having dynamic digital emulation models that cannot be reconfigured in real time or at least near real-time (e.g., a few seconds, less than a second, and optionally less than ten milliseconds or even less) will result in a model that simply cannot execute scenarios in reasonable time spans.

One exemplary product that enables such real time or at least near real-time reconfiguration of dynamic digital emulation models is Simulink® and/or Simulink Real-Time™ by speedgoat GmbH.

In a specific example, the model can be an electrical grid simulation model. In such cases, the reconfiguration of one or more second dynamic digital emulation models of the dynamic digital emulation models can cause a connection of at least one of the second dynamic digital emulation models to the electrical grid simulation model or a disconnection of at least one of the second dynamic digital emulation models from the electrical grid simulation model. For example, upon an overload event in a power station dynamic digital emulation model (being an exemplary first dynamic digital emulation model) taking place, an overload operational procedure is executed which causes a reconfiguration of an emergency generator dynamic digital emulation model (which is an exemplary second dynamic digital emulation models) which causes it to connect to the electrical grid simulation model in order to provide required power to the electrical grid.

The scenarios simulating real-world scenarios that can be executed on the model include, for example (non-limiting):
Changing one or more of the modeled components—testing and validating impacts of such changes (minor changes, upgrades) on the critical infrastructure;
Replacing one or more modeled components or adding new modeled components—testing and validating impacts of such changes (replacements, addition of new hardware and/or software) on the critical infrastructure;
Changes in the external environment—testing and validating impacts of changes in the external environment on the modeled critical infrastructure, such as new threats, new vulnerabilities, new attacks, or any other new risk;
Vulnerabilities Mitigation—mapping and identifying risks and vulnerabilities within the modeled critical infrastructure, and optionally creating a sustainable mitigation plan;
Post recovery process—testing and validating the modeled critical infrastructure during post compromise recovery processes.
Cyber by Design—Testing the modeled critical infrastructure at the design stage of any new, upgraded, or redesigned modeled component.

In a specific example, one or more cyber-attacks can be simulated on the model as one of the scenarios simulating real-world scenarios. In such cases, the cyber-attack that is simulated on the model can be based on MITRE ATT&CK® ICS framework or on MITRE ATT&CK® framework.

Another specific example includes a simulation of an ongoing cyber-attack occurring on the critical infrastructure that the model is modeling. This can enable analysts that are trying to deal with an ongoing cyber-attack take measures that are validated by the model so that the measures that are taken do not harm the critical infrastructure, and are proven to have a positive impact on the ongoing situation (e.g., stop the cyber-attack, reduce risks as a result of the cyber-attack, etc.).

During, or after, execution of the scenarios, the system 100 analyzes the model to identify implications of the execution of the scenarios (block 230). Identification of the implications of the execution of the scenarios can enable identifying the effects of the scenarios on the critical infrastructure, whether positive (closing security breaches, improving performance, etc.), or negative (causing damage to the critical infrastructure, creating security breaches, etc.).

It is to be noted that in those cases where the model is connected to one or more physical components of the critical infrastructure (e.g., via connectors 105), the system 100 can also analyze the implications of the execution of the scenarios on the physical components to which the model is connected.

In some cases, system 100 can be further configured to perform one or more actions based on results of the analysis (block 240). In some cases, the actions can include one or more of:
alerting a user (e.g., notifying a user of system 100 of a security risk or vulnerability, or about any implications of the execution of the scenarios);
providing the user with information of one or more identified vulnerabilities;
providing the user with information of successful cyber-attacks performed on the model;
providing the user with information of a risk level associated with one or more of the components of the critical infrastructure;
providing the user with information of known adversaries that may pose a threat to the critical infrastructure (e.g., based on known mapping of attackers and their sectors of operation, their known attack strategies, their known attack tools, etc.); or
a suggesting the user to perform one or more remediation actions.

The remediation actions that system 100 can suggest the user to perform can include one or more of:
introduction of one or more missing Security Information and Event Management (SIEM) rules to a SIEM system monitoring the critical infrastructure or some components thereof;
reconfiguration of one or more of the components of the critical infrastructure;
change a topology of the critical infrastructure;
add components (hardware and/or software) to the critical infrastructure; or
a suggest to modify one or more parameters of the critical infrastructure.

In some cases, the suggested remediation actions that the system 100 can recommend are designed to deal with any negative implication of the execution of the scenarios, and/or to improve the critical infrastructure's sturdiness.

It is to be noted, with reference to FIG. 3, that some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Attention is now drawn to FIG. 4, a flowchart illustrating one example of a sequence of operations carried out for performing and validating remediation actions on the simulation and emulation critical infrastructure, in accordance with the presently disclosed subject matter.

In accordance with the presently disclosed subject matter, system 100 can be configured to perform a remediation process 300, e.g., using remediation module 140.

For this purpose, system 100 can be configured to automatically perform one or more remediation actions (discussed with reference to block 240 above) on the model (block 310) and validate that the remediation actions solve at least one negative implication of the implications of the execution of the scenarios as identified at block 230. Having the ability to perform the remediation actions on the model enables verifying that the suggested remediation actions will, on the one hand, have a positive impact in dealing with negative implications, and, on the other hand, will not have a negative effect on the model, or on any component thereof. Thus, when the remediation actions are implemented on the real-world critical infrastructure, due to the fact that they have been validated on the model that models the critical infrastructure, the remediation actions will improve the critical infrastructure (e.g., enhance its sturdiness, close security breaches, etc.).

It is to be still further noted, with reference to FIG. 4, that the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A simulation and emulation system for critical infrastructure, the critical infrastructure comprising one or more components, the system comprising at least one processing circuitry configured to:
obtain a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place;
execute one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models, other than the first dynamic digital emulation models;
analyze the model to identify implications of the execution of the scenarios; and
perform one or more actions based on results of the analysis.

2. The simulation and emulation system of claim 1, wherein the model is an electrical grid simulation model and wherein the reconfiguration of one or more second dynamic digital emulation models of the dynamic digital emulation models causes a connection of at least one of the second dynamic digital emulation models to the electrical grid simulation model or a disconnection of at least one of the second dynamic digital emulation models from the electrical grid simulation model.

3. The simulation and emulation system of claim 1, wherein at least one of the dynamic digital emulation models emulates at least one Operational Technology (OT) component.

4. The simulation and emulation system of claim 1, further comprising one or more virtual digital models, wherein each virtual digital model represents at least one of the components of the critical infrastructure.

5. The simulation and emulation system of claim 4, wherein the virtual digital models are Information Technology (IT) models.

6. The simulation and emulation system of claim 1, wherein the model is configured to connect to one or more physical components of the critical infrastructure.

7. The simulation and emulation system of claim 1, wherein at least one of the scenarios simulating real-world scenarios is a simulation of a cyber-attack.

8. (canceled)

9. The simulation and emulation system of claim 1, wherein the one or more actions are one or more of: alerting a user, suggesting one or more remediation actions, providing information of one or more identified vulnerabilities, providing information of successful cyber-attacks performed on the model, providing information of a risk level of each of one or more of the components, providing information of known adversaries.

10. The simulation and emulation system of claim 9, wherein the remediation actions include one or more of: introduction of one or more missing SIEM rules, reconfiguration of one or more of the components of the critical infrastructure, changing a topology of the critical infrastructure, adding components to the critical infrastructure or suggesting to modify one or more parameters of the critical infrastructure.

11. The simulation and emulation system of claim 10, wherein the processing circuitry is further configured to perform the remediation actions on the model and validate that the remediation actions solve at least one negative implication of the implications of the execution of the scenarios.

12. (canceled)

13. A simulation and emulation method for critical infrastructure, the critical infrastructure comprising one or more components, the method comprising:
obtaining a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place;
executing one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models, other than the first dynamic digital emulation models;
analyzing the model to identify implications of the execution of the scenarios; and
performing one or more actions based on results of the analysis.

14. The simulation and emulation method of claim 13, wherein the model is an electrical grid simulation model and wherein the reconfiguration of one or more second dynamic digital emulation models of the dynamic digital emulation models causes a connection of at least one of the second dynamic digital emulation models to the electrical grid simulation model or a disconnection of at least one of the second dynamic digital emulation models from the electrical grid simulation model.

15. The simulation and emulation method of claim 13, wherein at least one of the dynamic digital emulation models emulates at least one Operational Technology (OT) component.

16. The simulation and emulation method of claim 13, further comprising one or more virtual digital models, wherein each virtual digital model represents at least one of the components of the critical infrastructure.

17. The simulation and emulation method of claim 16, wherein the virtual digital models are Information Technology (IT) models.

18. The simulation and emulation method of claim 13, wherein the model is configured to connect to one or more physical components of the critical infrastructure.

19. The simulation and emulation method of claim 13, wherein at least one of the scenarios simulating real-world scenarios is a simulation of a cyber-attack.

20. (canceled)

21. The simulation and emulation method of claim 13, wherein the one or more actions are one or more of: alerting a user, suggesting one or more remediation actions, providing information of one or more identified vulnerabilities, providing information of successful cyber-attacks performed on the model, providing information of a risk level of each of one or more of the components, providing information of known adversaries.

22. The simulation and emulation method of claim 21, wherein the remediation actions include one or more of: introduction of one or more missing SIEM rules, reconfiguration of one or more of the components of the critical infrastructure, changing a topology of the critical infrastructure, adding components to the critical infrastructure or suggesting to modify one or more parameters of the critical infrastructure.

23. (canceled)

24. (canceled)

25. A non-transitory computer readable storage medium having computer readable program code embodied therewith, the computer readable program code, executable by at least one processor to perform a simulation and emulation method for critical infrastructure, the critical infrastructure comprising one or more components, the method comprising:
obtaining a model including: (A) a plurality of dynamic digital emulation models, each: (i) modeling at least one of the components, being modeled components, (ii) configured to emulate behavior of the respective modeled components, (iii) having one or more parameters defining operation of the respective dynamic digital emulation model, and (iv) associated with one or more respective events, each event configured to cause a change in one or more of the parameters of the respective dynamic digital emulation model, and (B) one or more operational procedures configured to cause reconfiguration of one or more of the dynamic digital emulation models upon one or more of the events taking place;
executing one or more scenarios simulating real-world scenarios on the model, the scenarios comprised of a sequence of one or more actions, wherein at least one of the actions causes triggering at least one of the events, thereby causing changes to one or more of the parameters of one or more first dynamic digital emulation models of the dynamic digital emulation models, wherein the changes triggers execution of one or more of the operational procedures, thereby causing near real-time reconfiguration of one or more second dynamic digital emulation models of the dynamic digital emulation models, other than the first dynamic digital emulation models;
analyzing the model to identify implications of the execution of the scenarios; and
performing one or more actions based on results of the analysis.
